(19) United States
(12) Patent Application Publication
(10) Pub. No.: US 2001/0048220 A1
(43) Pub. Date: Dec. 6, 2001

(54) Device for steering a motor vehicle

(75) Inventor: Christian Lorenz, Leidersbach (DE)

Correspondence Address: TAROLLI, SUNDHEIM, COVELL,, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH & Co. KG

(21) Appl. No.: 09/862,863

(22) Filed: May 22, 2001

(30) Foreign Application Priority Data
May 22, 2000 (DE) 200 09 210.3

(51) Int. Cl. B62D 1/18; B60R 21/00

(52) U.S. Cl. 280/777; 180/271; 280/728.1

(57) ABSTRACT

The invention relates to a device for steering a motor vehicle having at least one steerable wheel. The device comprises at least one steering means to be actuated by a driver of the vehicle. The steering means is coupled electrically with the at least one steerable wheel of the motor vehicle for a transmission of steering signals. A drive is provided for a vertical adjustment of the steering means, which drive moves the steering means downwards in the case of an accident.

### TECHNICAL FIELD

The invention relates to a device for steering a motor vehicle.

### BACKGROUND OF THE INVENTION

Known steering devices comprise at least one steering means to be actuated by the driver, the means being coupled electrically with at least one steerable wheel of the motor vehicle for the transmission of steering signals. Such devices are known for example from DE 196 25 496 C2 or DE 196 25 498 C1.

These devices are also known as “steering-by-wire” steering systems, because the coupling of the steering means with the steerable wheels does not take place mechanically, as is conventional, but electrically. This has the advantage that a conventional steering wheel with a rigid steering shaft can be dispensed with, whereby space for the device is distinctly reduced.

### BRIEF SUMMARY OF THE INVENTION

The invention provides a device which is intended to make the “steering-by-wire” steering system very safe for drivers. This is achieved in a device which comprises at least one steering means to be actuated by a driver of the vehicle. The steering means is coupled electrically with the at least one steerable wheel of the motor vehicle for a transmission of steering signals. A drive is provided for a vertical adjustment of the steering means, which drive moves the steering means downwards in the case of an accident. The steering means is for ergonomic reasons always arranged in front of the occupant. If the steering means are also arranged to the side of the occupant, preferably are also fastened to the vehicle seat, they impede the driver on climbing out of the vehicle or they impede his being rescued after an accident. However, the device according to the invention makes provision for moving the steering means downwards automatically when the accident occurs whereby it is no hindrance when climbing out of the vehicle. This lowering of the steering means may take place by means of a swiveling movement or a linear movement which requires less space, or a combination of the two types of movement.

Preferably the steering means and the drive are arranged on the driver's seat, according to the preferred embodiment even on the seat part of the vehicle seat, so that the steering means and the vehicle seat can be displaced together. A further advantage of this arrangement consists in that the steering means does not have to be fastened in the vehicle door, which in a side impact, in contrast to the vehicle seat, can be subjected to intensive deformations. Furthermore, by coupling the steering means with the vehicle seat, the latter is able to be constructed in an identical manner both for right- and left-hand drive vehicles, so that the expenditure for altering a left-hand drive vehicle to a right-hand drive vehicle or vice versa can be kept low, because only the electrical signal transmission line is to be laid differently.

The drive should move the steering means downwards to beneath the seat area of the seat part, i.e. the upper side of the seat, so that it also can not be a hindrance when leaving the vehicle.

According to a development, the drive is coupled with an airbag module and with releasing of the airbag module also the steering means is moved downwards by the drive. In this development, it is possible to combine the controls for activating the airbag module and the drive or to provide an energy source, e.g. a pyrotechnic gas generator, which inflates the gas bag and also supplies the drive, e.g. a piston/cylinder unit, with energy.

However, the drive is able to move the steering means automatically downwards not only in the case of an accident, but rather, in addition, according to an embodiment it can also be actuated by the driver for the specific movement of the steering means upwards and downwards, so that the driver can place the steering means into an ergonomically favorable position.

### BRIEF DESCRIPTION OF THE DRAWINGS

FIG. 1 shows a side view of the device according to the invention and

FIG. 2 shows a top view onto the device according to FIG. 1.

### DETAILED DESCRIPTION OF THE PREFERRED EMBODIMENT

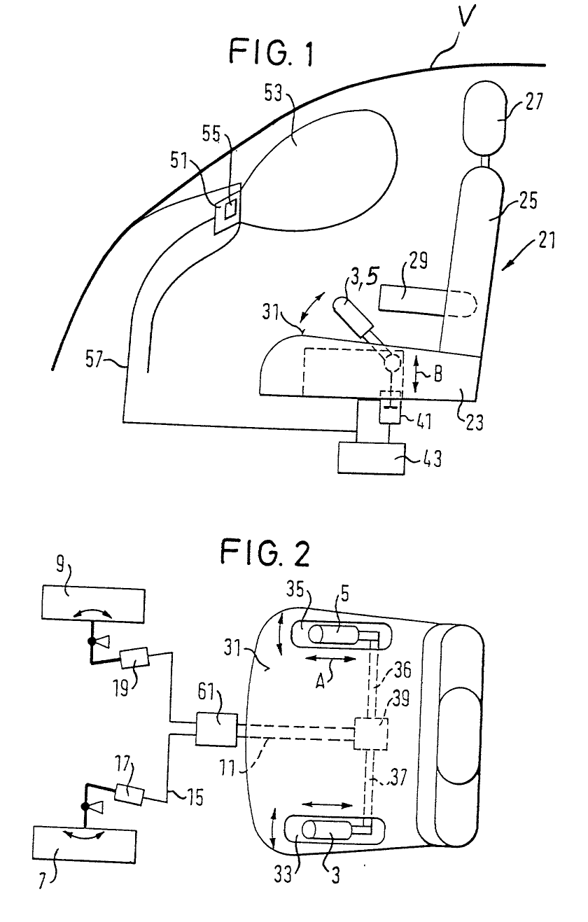

In FIG. 1 a device is shown for steering a motor vehicle (of which only a portion of contour V is illustrated), which manages without a mechanical coupling of the steering means, in the present case two joystick-like levers 3, 5 with steerable wheels 7, 9 of the vehicle. The steering means, the position of which is proportional to an electrical signal, are in fact coupled via electrical connecting lines 11, 15 with drives 17, 19 for deflecting the wheels 7, 9. This system is also named “steering-by-wire”. The device comprises a driver's seat 21, which has a seat part 23 and a pivoting backrest part 25 arranged thereon, and also a head support 27. Arm rests 29 can also be provided on the backrest part 25, which make possible a more relaxed driving and more relaxed steering. To the left and right of the driver, more precisely to the left and right of the seat area 31 to be occupied by him, the seat part 23 has in each case an elongated opening 33, 35, through which a steering means 3, 5 extends. The steering means 3, 5 are coupled with the seat part 23, so that with longitudinal displacement of the seat to adapt to the size of the driver or to make possible entry to the rear in a two- or three-door vehicle, the steering means 3, 5 are also displaced.

The steering means 3, 5 are coupled with each other mechanically by means of the swivel axes 35, 37 and an intercalated gear 39, so that a one-handed steering of the vehicle is possible.

For optimum adaptation of the position of the steering means 3, 5 to the stature of the driver, the steering means 3, 5 are jointly also longitudinally displaceable relative to the seat part 23 in the direction of arrow A, and namely independently of the steering movement. Furthermore, the steering means 3, 5 are also displaceable vertically by means of a drive 41 for lowering the steering means 3, 5. The drive 41 is actuated by means of a control arrangement 43 in which various drivers' profiles are stored, i.e. their setting of seat part 23, backrest part 25 and steering means 3, 5 (the latter in the basic position). Furthermore, the drive 41 is also coupled with an airbag module 51. The airbag module 51 comprises a gas bag 53 and a gas generator 55. With actuation of the gas generator 55, it is assumed that an accident is imminent and a steering maneuver has no further effect on the vehicle, so that for example the drive 41 is actuated electrically or by means of a gas line 57, which leads to the two steering means 3, 5 being displaced downwards, as symbolized by the arrow B. In the downwardly displaced position, the steering means 3, 5 lie completely beneath the seat area, in order to make possible an easier climbing in or out of the driver.

The vehicle seat together with the steering means 3, 5 is constructed such that it is able to be used equally for right- and left-hand drive vehicles.

The illustrated device functions as follows: When the driver opens the vehicle, each steering means 3, 5 is lowered by the drive 41 into the seat part 23 or remains lowered therein. To facilitate entry, the vehicle seat is automatically moved fully to the rear. After the driver has sat down, he inserts the ignition key into the ignition lock or inserts a corresponding chip card into a corresponding slit, whereupon the control arrangement 43 can verifiy his identity. The driver's seat 21 together with the steering means 3, 5 is brought in longitudinal direction into the optimum sitting position previously determined and stored by the driver, an adjustment of the seat rest 25 also being able to take place. In addition, the drive 41 is actuated and the steering means 3, 5 travel upwards, in order to project with respect to the seat area 31, as shown.

By moving the steering means 3, 5 forward and to the rear and in the opposite direction and also possibly laterally, the vehicle can be steered, because the setting of the steering means 3, 5 is constantly polled by means of sensors (not shown), and the corresponding pulses are sent to a central control unit 61. The control unit 61 processes the signals and controls the drives 17, 19 accordingly, in order to achieve the desired wheel deflection. Not only the desired wheel deflection but possibly also an acceleration or deceleration of the vehicle can be controlled by means of the setting of the steering means 3, 5.

In the case of an accident, not only is the gas bag 53 unfolded, but also the two steering means 3, 5, as already explained, are moved downwards.

In the embodiment according to FIG. 1 and 2, the driver can at option actuate the drive 23 for the vertical adjustment of the steering means 3, 5.

1. A device for steering a motor vehicle having at least one steerable wheel, said device comprising
at least one steering means to be actuated by a driver of said vehicle, said steering means being coupled electrically with said at least one steerable wheel of said motor vehicle for a transmission of steering signals, and
a drive for a vertical adjustment of said steering means, which drive moves said steering means downwards in the case of an accident.

2. The device according to claim 1, wherein said drive is arranged to move said steering means linearly downwards.

3. The device according to claim 1, wherein said vehicle is provided with at least one vehicle seat, said steering means and said drive being arranged on said vehicle seat.

4. The device according to claim 3, wherein said vehicle seat has a seat part on which said drive and said steering means are arranged.

5. The device according to claim 4, wherein said seat part has a seat area and wherein said steering means is moved downwards to beneath said seat area.

6. The device according to claim 1, wherein said drive is coupled with an airbag module and with activating of said airbag module said drive moves said steering means downwards.

7. The device according to claim 1, wherein said drive is also able to be actuated by said driver for a specific movement of said steering means upwards and downwards to achieve an ergonomically favorable position of said steering means.

8. The device according to claim 1, wherein one steering means each is arranged to the left and right of said seat area which is to be occupied by said driver.
